(19) United States
(12) Patent Application Publication
(10) Pub. No.: US 2012/0221663 A1
(43) Pub. Date: Aug. 30, 2012

(54) METHOD OF COMPILING AN ELECTRONIC MESSAGE

(75) Inventors: Edmund Charles Liebenberg, Broadbeach Waters (AU); Clint Hockings, Morayfield (AU)

(73) Assignee: Ehot Offer Asset Management Pty Ltd., Caboolture (AU)

(21) Appl. No.: 13/504,916

(22) PCT Filed: Oct. 29, 2010
(86) PCT No.: PCT/AU10/01449

§ 371 Date: Apr. 27, 2012

(30) Foreign Application Priority Data
Oct. 30, 2009 (AU) 2009905325

(51) Int. Cl. G06F 15/16

(52) U.S. Cl. 709/206

(57) ABSTRACT

A method of compiling an electronic message includes retrieving preferences of a recipient of the electronic message from a CRM system of the sender of the electronic message. Content matching the preferences of the recipient is inserted into the electronic message. The method includes receiving a basic electronic message at a mail server and comparing the sender's address with sender addresses in a subscriber database to determine if the sender is a subscriber. If the sender is a subscriber the recipient's address is matched to a recipient addresses in a recipient address database. The recipient's preferences are retrieved from the CRM system. Content, from a dynamic database of different content files, is matched to the recipient's preferences and inserted into the basic electronic message, thereby to compile the electronic message.

### FIELD OF THE INVENTION

The present invention relates generally to a method of compiling an electronic message and in particular, although not exclusively, the invention relates to selective insertion of dynamic content files into email messages.

### BACKGROUND TO THE INVENTION

Email is a prime business tool for communication to clients and customers. Email content generally comprises no more than the body text of the email generated by the sender and a personalized signature. There is a need to customize emails to better target the recipients by including relevant content.

Most companies have CRM systems wherein their clients/customers email addresses and preferences are captured. An example of a client preference in the real estate industry would be the type of property that interests the client. A real estate agent may manually copy content into an email to his client by looking at the client's preferences on the CRM system, searching for content that matches his client's preferences and then compiling an email including the content. Such an exercise is time consuming and laborious.

What is required is a system that automatically adds content to outgoing emails based on the email recipient's preferences as stored in the CRM system.

### SUMMARY OF THE INVENTION

In one form, although not necessarily the only or the broadest form, the invention resides in a method of compiling an electronic message, the method including:

receiving a basic electronic message at a mail server;

determining a sender's address;

comparing the sender's address with sender addresses in a subscriber database to determine if the sender is a subscriber;

determining a recipient's address;

comparing the recipient's address with recipient addresses in a recipient address database;

retrieving at least one preference of the recipient from a customer relationship management (CRM) system storing preferences of the recipient if the recipient's address is matched in the recipient addresses database and if the sender is a subscriber;

matching one or more content files, from a dynamic database of different content files, with the recipient's preference; and

inserting the content files matched to the recipient's preference into the basic electronic message, thereby to compile the electronic message.

The mail server is preferably an email server and the electronic message is an email. The compiled electronic message is sent to the recipient's address from the mail server.

Matching the content files with the recipient's preference preferably comprises matching the recipient's preference to metadata of the different content files.

The method preferably includes retrieving a template for the sender if the sender is determined to be a subscriber and inserting code for customising the email in accordance with the template retrieved for the sender.

The CRM system of the sender is preferably identified by associating the senders email address with the CRM system.

The recipient's address is preferably determined and compared with recipient addresses in the recipient address database only if the sender is a subscriber.

In accordance with another aspect of the invention there is provided a mail server operable to compile an electronic message, the mail server adapted to receive a basic electronic message, and wherein the mail server is operable to compile the electronic message by:

determining a sender's address;

comparing the sender's address with sender addresses in a subscriber database to determine if the sender is a subscriber;

determining a recipient's address;

comparing the recipient's address with recipient addresses in a recipient address database;

retrieving at least one preference of the recipient from a customer relationship management (CRM) system storing preferences of the recipient if the recipient's address is matched in the recipient addresses database and if the sender is a subscriber;

matching one or more content files, from a dynamic database of different content files, with the recipient's preference; and

inserting the content files matched to the recipient's preference into the basic electronic message, thereby to compile the electronic message.

The mail server preferably includes the subscriber database. The mail server may also include the CRM system and the recipient address database.

In accordance with yet another aspect of the invention there is provided a system for compiling an electronic message, the system including:

a mail server at which a basic electronic message is receivable;

a subscriber database of addresses of senders who are subscribers;

a CRM system having a recipient database of recipient addresses and a database of recipient preferences associated with the recipient addresses; and

a dynamic content database having content files which can be matched to the recipient preferences;

wherein the mail server is operable to determine if a sender of the basic electronic message is a subscriber and insert content files into the basic electronic message, the content files matched to the recipient's preference of a recipient of the electronic message via the CRM system if the sender is a subscriber.

The system preferably includes a database of templates comprising templates for each subscriber.

### BRIEF DESCRIPTION OF THE DRAWINGS

By way of example only, preferred embodiments of the invention will be described more fully hereinafter with reference to the accompanying figures, wherein:

FIG. 1 is a diagram illustrating a system for compiling and forwarding an email from a sender to a recipient over a network, in accordance with one embodiment of the invention; and

FIG. 2 is a flow diagram illustrating the process of compiling an electronic message in accordance with the present invention.

### DETAILED DESCRIPTION OF THE DRAWINGS

The present invention relates to a method of compiling an electronic message. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

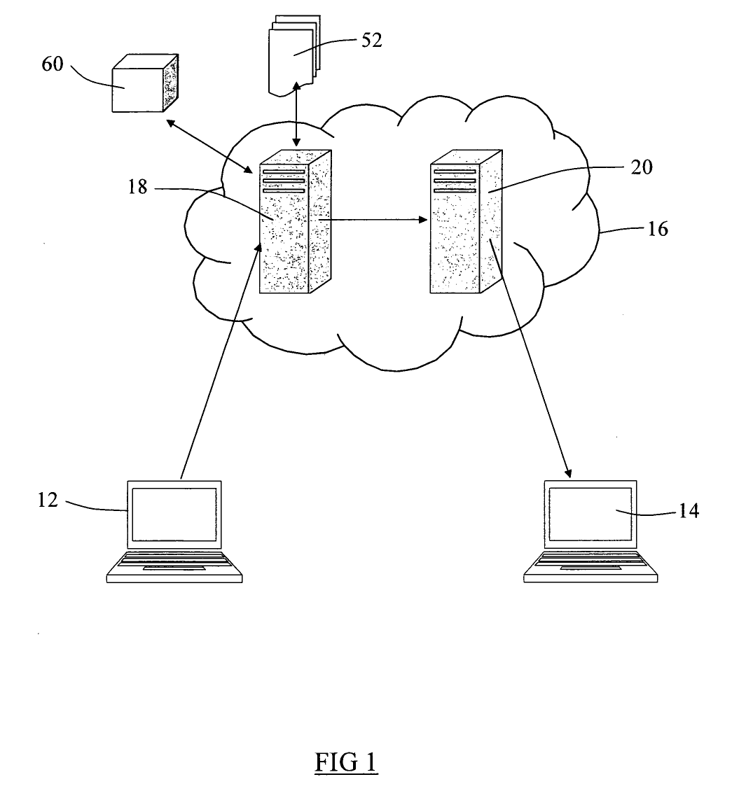

In the drawings, like reference numerals refer to like parts. Referring to FIG. 1, there is shown a diagram of a system for compiling an electronic message in the form of an email, and forwarding an email from a sender terminal 12 to a recipient terminal 14 over a network 16 such as the world wide web. The computer terminals 12, 14 may be any device such as a laptop, desktop, palmtop or smart phone capable of connecting to the network 16. A basic email composed by the sender at the sender terminal 12 is forwarded to a mail server 18 where it is compiled. From the mail server 18, the compiled email passes to a recipient server 20 before it is retrieved by the recipient terminal 14. The email is compiled by retrieving recipient preferences from a customer relationship management (CRM) system 60 and adding content from a dynamic content database 52 specific to the recipient preferences. The mail server 18 interrogates the CRM system 60 for the recipient's preferences and adds matched content files form the dynamic content database 52.

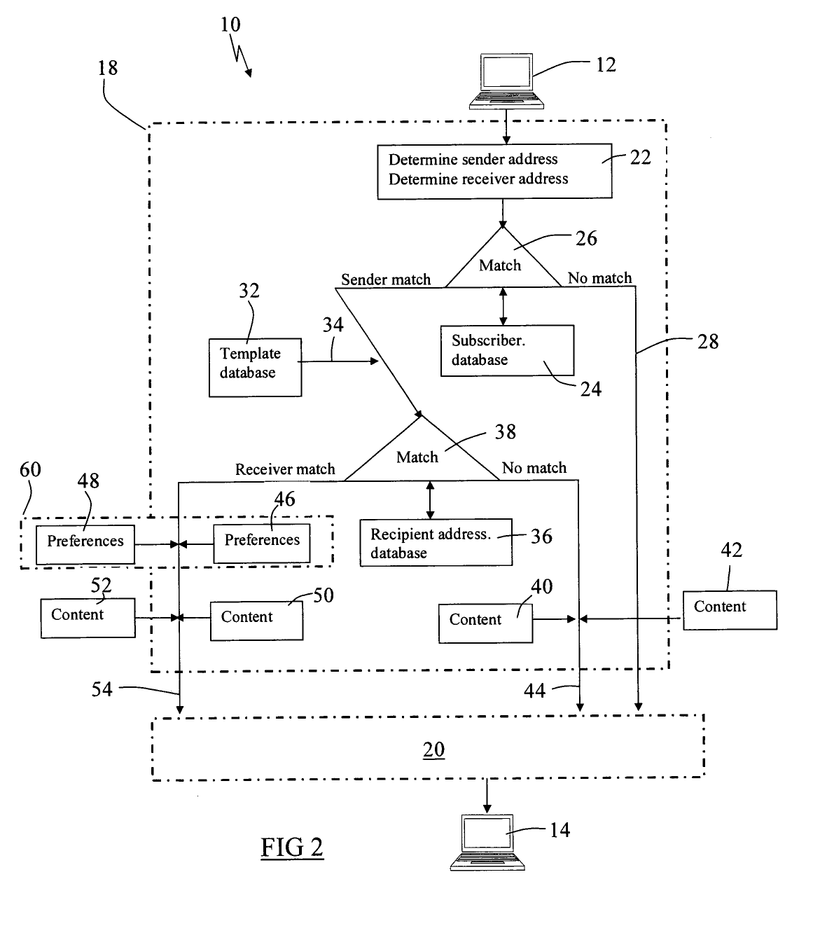

FIG. 2 shows a method 10 of how a basic email composed by the sender at the sender terminal 12 is compiled at the mail server 18 by selectively adding content as described hereinbelow. The compiled email is then relayed to the recipient terminal 14 via the recipient server 20.

The basic email composed at the sender terminal 12 has header data containing at least a sender address and a recipient address. The basic email is received at the mail server 18 where the header data is analysed by the server 18 to determine the sender address and the recipient address of the basic email. The step of determining the sender address and the recipient address is indicated by reference 22.

The server 18 has a subscriber database 24 of sender email addresses who are subscribers. The subscriber database 24 contains email addresses of persons who subscribe to a service for having their basic emails compiled in accordance with the present invention. The subscriber database 24 thus stores the email addresses of subscribers subscribed to the service. Although the database 24 is shown as being on the server 18, it will be appreciated that the database 24 can be located on any storage remote from the server 18 and accessed by the server 18.

The server 18 compares the sender address determined at step 22 with the sender email addresses stored in the subscriber database 24. The step of comparing the sender address from the header data to the sender email addresses in the subscriber database 24 is indicated as a matching function by reference 26.

If the sender address from the header data does not match with any of the sender email addresses of the subscribers in the subscriber database 24, no content is added to the basic email and the basic email is forwarded to the recipient server 20 without change. Arrow 28 indicates forwarding a basic email which was not matched to any of the sender email addresses in the subscriber database 24, to the recipient server 20.

The server 18 includes a template database 32 of email templates for each of the sender email addresses stored in the subscriber database 24. If there is a match at 26, that is to say that the sender is a subscriber, then the server 18 retrieves the template for that sender email address from the template database 32. The template comprises code inserted into the basic email to customise the email. The code contains tags for specific data and image types and preset formatting for the basic email. Inserting the code into the matched basic email is indicated by arrow 34. A basic email with code inserted in accordance with it's template as described hereinabove is referred to as a templated email.

The server 18 has a recipient address database 36 of recipient email addresses. The server 18 compares the recipient address determined at step 22 with the recipient email addresses stored in the recipient address database 36. The step of comparing the recipient's address to the recipient email addresses in the recipient address database 36 is indicated as a matching function by reference 38. The recipient address database 36 of recipient email address is a database of client/customer email addresses in the CRM system 60, or a copy of the client/customer email addresses from the CRM system 60. As such, an email to a client of the subscriber whose email address is captured in the CRM system 60 of the subscriber will be positively matched at 38.

If there is no match at 38, the templated email is compiled by adding content in accordance with the code of its template. The content may be content stored in a database 40 on the server 18 and/or or content from a dynamic database 42 outside the server. Similarly, the content 40 on the server may also be dynamic. Dynamic content is content such as image files which are regularly updated by adding and deleting files. The code of the templated email may, for example, call for content having specific metadata. The databases 40, 42 of content will include a number of content files with metadata and the content file(s) having the metadata required by the code of the templated email will be inserted into the email to compile the email. A templated email being compiled by adding content in accordance with the code of the template is indicated by arrow 44. The compiled email 44 is then forwarded to the recipient server 20.

If there is a match at 38 between the recipient address in the templated email and the recipient's email address stored in the recipient address database 36, the templated email is compiled to include content specific to the recipient's preferences. The recipient's preferences are stored in a recipient preference database 46 or 48, which form part of the customer relationship management (CRM) system 60. The CRM system 60 may be on the server 18 or external to the server 18 such as being located at a server of the subscriber. The CRM system 60 is specific for each subscriber. As such, the sender preference database 46 is on the server 18, and the sender preference database 48 is remote from the server 18. Only one of the databases 46, 48 is required, although both are depicted in FIG. 2. The server 18 retrieves the recipient preferences from one of the sender preference databases 46, 48 and then searches dynamic content databases 50, 52 for content files which match the sender preferences. The content database 50 is on the server 18 and the content database 52 is a third party database of content. The dynamic content databases 50, 52 include data content which is updated by adding and deleting content files. The content on the content databases 50, 52 have metadata for different content files. The content files are matched to the recipient preferences by matching the recipient preferences to the metadata. As such, the metadata contains information which can be matched to the recipient preferences. Content matching the recipient's preferences are inserted into the templated email to form a compiled email 54. The compiled email 54 is then forwarded to recipient server 20.

The recipient terminal 14, retrieves the compiled emails 44, 54 from the recipient server 20. If the recipient terminal 14 is that of a person which has his/her recipient preferences stored in one of the recipient preference databases 46, 48 then a compiled email 54 including recipient specific content is retrieved. If the recipient terminal 14 is not that of a person which has his/her recipient preferences stored in one of the recipient preference databases 46, 48 then a compiled email 44 which is only compiled in accordance with the sender's template is retrieved. If the sender is not a subscriber then the basic email 28 is retrieved by the recipient terminal.

The embodiment of the invention described may have application in an industry such as property sales and leasing. An estate agent may subscribe to a service compiling emails as described with reference to FIG. 2. The estate agent's email address will thus be stored in the subscriber database 24 as a sender email address of a subscriber. The estate agent will also have the CRM system 60 on which client's preferences are stored. The client's preferences are associated with the client's email address. These preferences may include things like the price bracket, area and type of property in which the client is interested. When an email is sent to one of the client's in the CRM system 60 from the agent, the code for the template of the agent is first added to the basic email and the templated email is then compiled by inserting content specific to the client's preferences retrieved from the CRM system 60. The content may be image files depicting a property and a description of the property, retrieved from third party property agent databases, which have metadata which match the client's preferences. The metadata is thus attributes such as price, area and type of property of the property depicted in the image file. The client will thus receive an email formatted in accordance with the estate agent's template and which includes content specific to the client's preferences.

Throughout the specification, the aim has been to describe the preferred embodiments of the invention without limiting the invention to any one embodiment or specific collection of features. The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method of compiling an electronic message, the method including:
receiving a basic email, having a header containing at least a sender's address and a recipient's address, at a mail server;
determining the sender's address from the header;
comparing the sender's address with sender addresses in a subscriber database to determine if the sender is a subscriber;
determining the recipient's address from the header;
comparing the recipient's address with recipient addresses in a recipient address database;
retrieving at least one preference of the recipient from a customer relationship management (CRM) system storing preferences of the recipient if the recipient's address is matched in the recipient addresses database and if the sender is determined to be a subscriber;
matching one or more content files, from a dynamic database of different content files, with the recipient's preference; and
inserting the content files matched to the recipient's preference into the basic electronic message, thereby to compile the email.

2. The method of claim 1, including sending the compiled email to the recipient's address from the mail server.

3. The method of claim 1, wherein matching the content files with the recipient's preference comprises matching the recipient's preference to metadata of the different content files.

4. The method of claim 1, including retrieving a template for the sender if the sender is determined to be a subscriber.

5. The method of claim 4, including inserting code for customising the email in accordance with the template retrieved for the sender.

6. The method of claim 1, including identifying a CRM system of the sender and retrieving the recipient preferences from the CRM system identified for the sender.

7. The method of claim 6, wherein the CRM system is identified by associating the sender's email address with the CRM system.

8. The method of claim 1, wherein the recipient's address is determined and compared with recipient addresses in the recipient address database only if the sender is a subscriber.

9. A mail server operable to compile an email, the mail server adapted to receive a basic email having a header containing at least a sender's address and a recipient's address, and wherein the mail server is operable to compile the email by:
determining the sender's address from the header;
comparing the sender's address with sender addresses in a subscriber database to determine if the sender is a subscriber;
determining the recipient's address from the header;
comparing the recipient's address with recipient addresses in a recipient address database;
retrieving at least one preference of the recipient from a customer relationship management (CRM) system storing preferences of the recipient if the recipient's address is matched in the recipient addresses database and if the sender is determined to be a subscriber;
matching one or more content files, from a dynamic database of different content files, with the recipient's preference; and
inserting the content files matched to the recipient's preference into the basic email, thereby to compile the electronic message.

10. The mail server of claim 9, wherein the mail server includes the subscriber database.

11. The mail server of claim 9, wherein the mail server includes the CRM system.

12. The mail server of claim 9, wherein the mail server includes the recipient address database.

13. A system for compiling an email, the system including:
a mail server at which a basic email having a header containing at least a sender's address and a recipient's address is receivable;
a subscriber database of addresses of senders who are subscribers;
a CRM system having a recipient database of recipient addresses and a database of recipient preferences associated with the recipient addresses; and
a dynamic content database having content files which can be matched to the recipient preferences;
wherein the mail server is operable to determine the sender's address from the header, determine if a sender of the basic email is a subscriber based on the sender's address, determine the recipient's address from the header, determine if the recipient's address is in the CRM system, and insert content files into the basic electronic message, the content files matched to the recipient's preference of a recipient of the electronic message via the CRM system if the sender is determined to be a subscriber and if the recipient's address is determined to be in the CRM system.

14. The system of claim 13, wherein the content files include metadata for matching the recipient's preference to the different content files.

15. The system of claim 13, including a database of templates comprising templates for each subscriber.

16. The method of claim 2, wherein matching the content files with the recipient's preference comprises matching the recipient's preference to metadata of the different content files.

17. The mail server of claim 10, wherein the mail server includes the CRM system.

18. The mail server of claim 10, wherein the mail server includes the recipient address database.

19. The mail server of claim 11, wherein the mail server includes the recipient address database.

20. The system of claim 14 including a database of templates comprising templates for each subscriber.
